(19) United States
(12) Patent Application Publication
(10) Pub. No.: US 2015/0172550 A1
(43) Pub. Date: Jun. 18, 2015

(54) DISPLAY TILING FOR ENHANCED VIEW MODES

(71) Applicant: MOTOROLA MOBILITY LLC, Libertyville, IL (US)

(72) Inventor: John Thomas Bretscher, Elgin, IL (US)

(73) Assignee: MOTOROLA MOBILITY LLC, Libertyville, IL (US)

(21) Appl. No.: 14/107,990

(22) Filed: Dec. 16, 2013

(51) Int. Cl. H04N 5/232; G01B 11/14

(52) U.S. Cl. CPC H04N 5/23293; G01B 11/14; H04N 5/23296

(57) ABSTRACT

This document describes techniques (300, 500, 600) and apparatuses (102, 700) for implementing display tiling for enhanced view modes. These techniques (300, 500, 600) and apparatuses (102, 700) enable a computing device to apply a zoom-factor to a portion of a scene to provide a sub-portion of the scene for presentation on a display. The zoom-factor is applied such that the sub-portion of the scene appears unmagnified with respect to the scene that is not occluded by the computing device. By so doing, the sub-portion of the scene presented by the display may “tile” into the scene allowing contextual information to be presented to a user.

### BACKGROUND

This background description is provided for the purpose of generally presenting the context of the disclosure. Unless otherwise indicated herein, material described in this section is neither expressly nor impliedly admitted to be prior art to the present disclosure or the appended claims.

Computing devices often include multimedia capabilities that enable a user to capture images, record video, or communicate using video-based telephony and messaging services. To implement these multimedia capabilities, computing devices typically support cameras that are configured to capture scenery of an environment or, when implementing communication services, the user in the context of the scenery. Imagery received by the cameras can be presented via a user interface through a display of the computing device, which enables the user to select which imagery of the environment to capture, record, or stream.

### BRIEF DESCRIPTION OF THE DRAWINGS

Techniques and apparatuses enabling display tiling for enhanced view modes are described with reference to the following drawings. The same numbers are used throughout the drawings to refer to like features and components.

FIG. 1 illustrates an example environment in which techniques of display tiling for enhanced view modes can be implemented.

FIG. 2 illustrates an example computing device capable of implementing display tiling for enhanced view modes.

FIG. 3 illustrates an example method of applying a zoom-factor to a portion of a scene.

FIG. 4 illustrates another example environment in which techniques of display tiling for enhanced view modes can be implemented.

FIG. 5 illustrates methods of display tiling in accordance with one or more embodiments.

FIG. 6 illustrates an example method of presenting tiled scenery via a display of a device.

FIG. 7 illustrates various components of an electronic device that can implement techniques of display tiling for enhanced view modes.

### DETAILED DESCRIPTION

Conventional techniques for implementing a viewfinder often present camera-captured scenery of an environment through a display of a device. A physical housing of the device, however, may occlude a user's view of other scenery of the environment, such as various areas of background scenery. This may prevent the user from seamlessly interacting with, or easily capturing images from, the environment because the other scenery of environment is occluded by the device.

This disclosure describes techniques and apparatuses that facilitate display tiling for enhanced view modes, which enable a computing device to apply a zoom-factor to a portion of a scene to provide a sub-portion of the scene for presentation by a display. The zoom-factor may be applied such that the sub-portion of the scene appears unmagnified with respect to an area of the scene that is not occluded by the computing device. By so doing, imagery presented by the display may “tile” into the background scenery enabling intuitive exploration of an environment, as the sub-portion of the scene presented dynamically updates to reflect changes of the device's orientation within the environment. In effect, the display of the device may appear see-through or transparent, with the device functioning much like a digital window or viewport into the environment. Additionally, enhanced view modes may provide additional contextual information that enables a user to more fully experience or interact with the environment.

The following discussion first describes an operating environment, followed by techniques that may be employed in this environment, and ends with example apparatuses.

Operating Environment

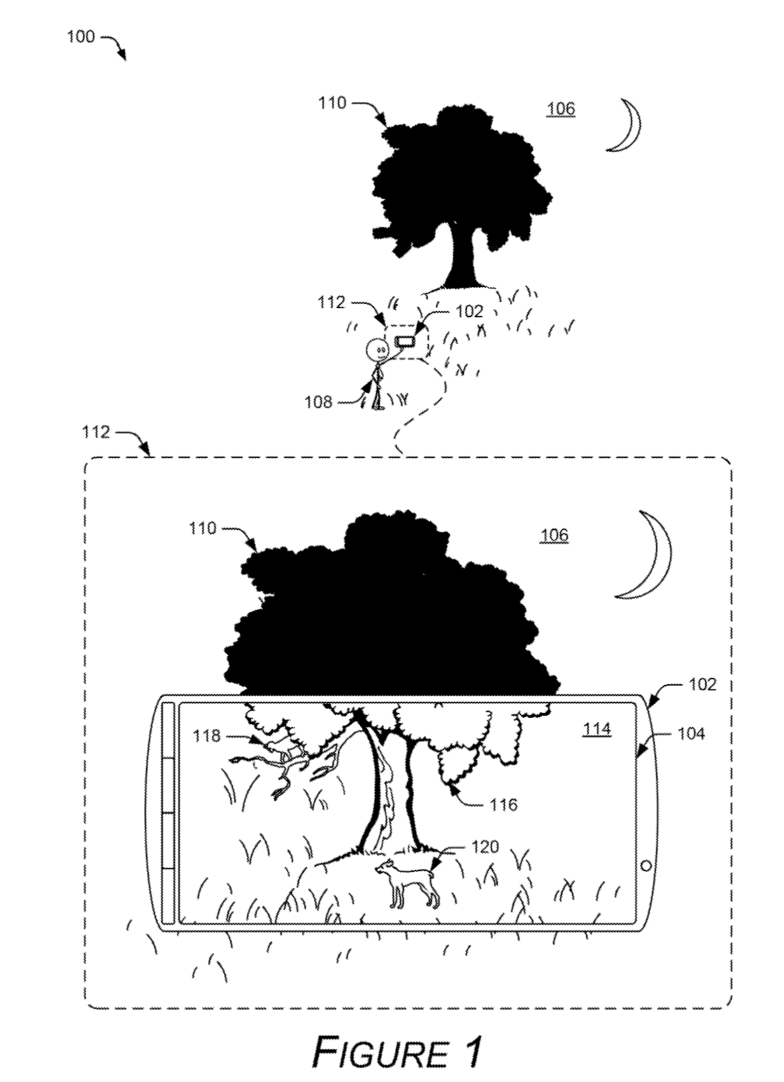

FIG. 1 illustrates an example environment 100 in which techniques described herein can be implemented. Environment 100 includes a computing device 102 having a display 104 through which portions of scene 106 are presented to a user. Portions of scene 106 are captured by a camera (not shown) of computing device 102, which may be located on a surface of computing device 102 that is opposite to a surface on which display 104 is located. In some embodiments, the camera of computing device 102 is capable of sensing light that is not perceivable by the human eye, such as infrared, ultraviolet, or low-lux light.

Display 104 may present a user interface for configuring the camera of computing device 102 and selecting which portions or sub-portions of scene 106 are presented by display 104 (e.g., a viewfinder interface). Which portions of scene 106 are presented by display 104 depend on how a user orientates computing device 102 with respect to environment 100. An example of one such orientation is shown in FIG. 1, in which user 108 is shown standing in a field surrounded by various elements, such as tree 110. In this particular example, user 108 is standing in the field at night and tree 110 appears, to user 108 when not viewed through display 104, as a vague object overshadowed by moonlight.

By orienting computing device 102 (and the camera thereof) toward tree 110, user 108 is able to view at least a portion of tree 110 through display 104 of computing device 102. For visual clarity, a detailed view of scene 106 from a perspective of user 108 is shown at user view 112. As shown by user view 112, some of scene 106 is occluded by a physical housing of computing device 102, while other areas of scene 106 not occluded by computing device 102 can still be seen by user 108. Additionally, user 108 may view a portion of scene 106 captured or sensed by the camera and presented via display 104, shown as sub-portion 114 of scene 106.

The sub-portion 114 of scene 106 may be presented such that sub-portion 114 occupies substantially all of display 104. In some cases, sub-portion 114 is an entire portion of scene 106 captured by the camera of computing device 102. Alternately or additionally, visual aspects of sub-portion 114 may be altered or augmented such that sub-portion 114 tiles or meshes with other portions of scene 106. For example, imagery captured by the camera of computing device 102 may be zoomed, panned, or rotated to scale or align objects (or portions thereof) of sub-portion 114 with corresponding objects of scene 106, such as tree 110.

Alternately or additionally, computing device 102 may leverage capabilities of the camera to present aspects of sub-portion 114 that are not normally within a visible spectral range of a user. In the context of the present example, this is shown in FIG. 1 as elements near tree 110 being visible in sub-portion 114, while other element of scene 106, such as a top of tree 110, are not visible without the aid of computing device 102. Here, low-lux capabilities of the camera are leveraged to increase a brightness of elements captured by the camera, in effect providing night-vision. Thus, user 108 is able to see details and objects of scene 106 that are otherwise not perceivable at night, such as leaves 116 of tree 110 and cat 118, which has been chased up tree 110 by dog 120. This is but one example of display tiling and an enhanced view mode. How computing device 102 is implemented to provide display tiling and other enhanced view modes may vary and is described below.

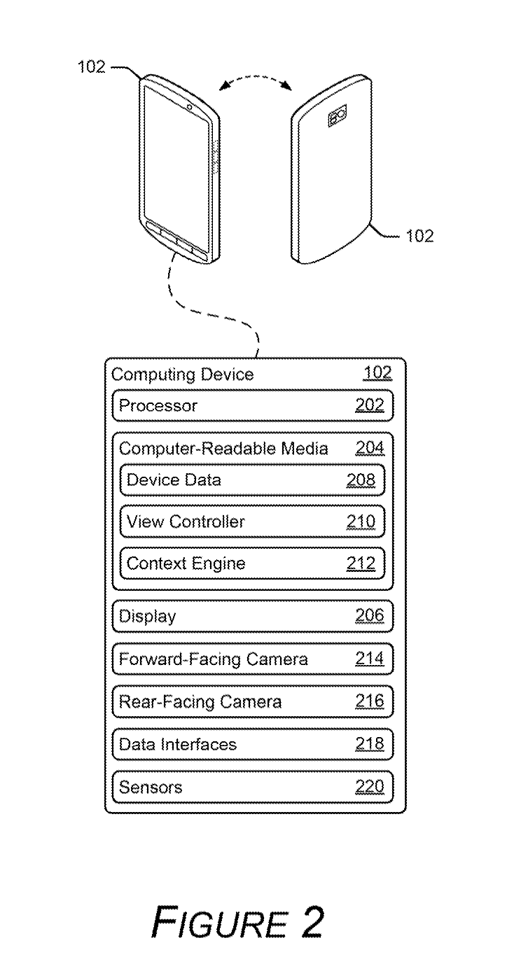

More specifically, consider FIG. 2, which illustrates an example embodiment of computing device 102 of FIG. 1. Computing device 102 can be, or include, many different types of computing or electronic devices capable of implementing display tiling for enhanced view modes. In this example, computing device 102 is shown as a smart phone, though other devices are contemplated. Other computing devices 102 may include, by way of example only, a cellular phone, notebook computer (e.g., netbook or ultrabook), camera (compact or single-lens reflex), smart-watch, smart-glasses, tablet computer, personal media player, personal navigating device (e.g., global positioning system), gaming console, desktop computer, video camera, or portable gaming device.

Computing device 102 includes processor 202, which may be configured as a single or multi-core processor capable of enabling various functionalities of computing device 102. In some cases, processor 202 includes a digital-signal processing subsystem for processing various signals or data of computing device 102. Processor 202 may be coupled with, and may implement functionalities of, any other components or modules of computing device 102 that are described herein.

Computing device 102 includes computer-readable media 204 (CRM 204) and display 206. Computer-readable media 204 include device data 208, such as an operating system, firmware, or applications of computing device 102 that are executable by processor 202. Alternately or additionally, device data 208 may include various user data, such as images, music, documents, emails, contacts, and the like. CRM 204 also include view controller 210 and context engine 212, which in this example are embodied as computer-executable code stored on CRM 204.

View controller 210 manages visual aspects or effects applied to imagery presented by display 206. For example, view controller 210 may alter (e.g., control or manipulate) an aspect ratio, pan, rotation, optical-depth, zoom, crop, stretch, or shrink applied to imagery processed by computing device 102 or presented by display 206. Alternately or additionally, view controller 210 may configure or manage settings associated with cameras of computing device 102. Further implementations and uses of view controller 210 vary and are described below in greater detail.

Context engine 212 provides context for imagery presented by display 206. Context engine 212 may alter imagery presented by display 206, such as by inserting contextual information, icons, or indicators into the imagery. These contextual indicators provide additional information about elements or objects in the imagery presented by display 206. Alternately or additionally, these contextual indicators may provide other functionality, such as social tagging, linking to related websites, or communicating with proximate devices associated the elements or objects shown in the imagery. Contextual information may be inserted or conveyed using any suitable type of indicator, such as a navigational indicator, social indicator, service-related indicator, product-related indicator, news-related indicator, promotional indicator, and the like. Further implementations and uses of context engine 212 vary and are described below in greater detail.

Display 206 presents imagery or content for viewing by a user. Display 206 may be implemented as, or similar to, display 104 as described with reference to FIG. 1. In some cases, the user can interact with content-related applications or graphical user-interfaces of computing device 102 through display 206. In such cases, the display may be associated with, or include, a touch-sensitive input device (e.g., touch-screen) through which user input is received. Display 206 can be configured as any suitable type of display, such as an organic light-emitting diode (OLED) display, active matrix OLED display, liquid crystal display (LCD), in-plane shifting LCD, and so on.

Computing device 102 may also include forward-facing camera 214 and rear-facing camera 216, which are configured to sense or capture imagery or scenery surrounding computing device 102. Reference to camera direction is made by way of example only and is not intended to limit a position, orientation, or functionality of a camera. Thus, one or more cameras may be implemented on, or in association with, a computing device in any suitable way to enable aspects of display tiling for enhanced view modes.

In this example, forward-facing camera 214 may be implemented on a surface of computing device 102 that is opposite a surface on which display 206 is implemented. In at least some embodiments, display 206 presents real-time imagery captured by forward-facing camera 214, such as when configured as a viewfinder of computing device 102. Thus, as a user orients or re-orients computing device 102 within an environment, imagery presented by display 206 changes as forward-facing camera 214 captures different scene imagery of the environment.

Imagery captured by forward-facing camera 214 may be altered by view controller 210 or context engine 212 for presentation on display 206. For example view controller 210 may alter zoom settings of forward-facing camera 214 effective to magnify or scale the imagery when presented by display 206. In some cases, forward-facing camera 214 implements high-dynamic-range (HDR) imaging to more accurately represent brightness intensity levels of imagery. In such cases, capturing the imagery using exposure bracketing enables forward-facing camera 214 to provide HDR imagery data. Post-processing of the HDR imagery data may provide an HDR image or composite in which contrast of the imagery captured by forward-facing camera 214 is enhanced or exaggerated.

Alternately or additionally, forward-facing camera 214 may be sensitive to spectral ranges of light that are different from light that is visible to the typical human eye. The different spectral ranges of forward-facing camera 214 may include infrared light, ultraviolet light, low-lux light, or increased sensitivity to light within a particular range of visible light. In some cases, light captured in a different spectral range is leveraged to provide an enhanced view mode in which the light of the different spectral range is visually represented via display 206 (e.g., night vision).

Rear-facing camera 216 may be implemented on a surface of computing device 102 on which display 206 is implemented, or another surface parallel thereto. Thus, in some embodiments rear-facing camera 216 faces a same direction as display 206 and towards a user viewing display 206. Display 206 can also present real-time imagery or content captured by rear-facing camera 216, such as during video chat or messaging. In some cases, a distance from computing device 102 to a user is determined via rear-facing camera 216. For example, view controller 210 or another application of computing device 102 may implement facial detection via rear-facing camera 216 to determine this distance. Detecting distance by facial detection may include estimating or measuring distances between facial features of a user. A distance to the user can then be calculated based on a geometry of the detected facial features. In other cases, rear-facing camera 216 may be used in conjunction with other components of computing device 102 to provide additional functionality.

Computing device 102 includes data interfaces 218 for communicating data via a network or other connection. In some cases, these data interfaces 218 are wireless transceivers for communicating via a wireless network (not shown) or directly with other devices, such as by near-field communication. Examples of these wireless networks include a wireless wide-area network (WWAN), wireless local-area network (WLAN), and wireless personal-area network (WPAN), each of which may be configured, in part or entirely, as infrastructure, ad-hoc, or mesh networks. For example, an interface configured as a short-range wireless transceiver may communicate over a WPAN in accordance with a Bluetooth™ protocol.

In some embodiments, a distance between computing device 102 and a user may be determined using a data interface 218 when configured as a wireless transceiver. For example, a communication link with a wirelessly enabled peripheral being worn by, or attached to, a user can be established via a WPAN or WLAN transceiver. Characteristics of this communication link can be used by view controller 210 to determine the distance between computing device 102 and the user in a variety of ways. For example, view controller 210 can cause computing device 102 to emit a sound pulse at a certain frequency and receive, via the communication link, an indication of when the wirelessly-enabled peripheral receives the sound pulse. View controller 210 can then calculate a distance to the peripheral, and thus the user, based on a difference between the speed of sound and a speed of the communication link (including processing and transactional latencies). In other cases, an acoustic sensor of computing device 102 can sense a reflection of the sound pulse from the user and determine the distance based on the speed of sound.

Alternately or additionally, data interfaces 218 include wired data interfaces for communicating with other devices, such as local area network (LAN) Ethernet transceiver, serial data interface, audio/video port (e.g., high-definition multimedia interface (HDMI) port), or universal serial bus (USB) port. These wired data interfaces may be implemented using standard connectors or through the use of proprietary connectors and associated cables providing enhanced security or interconnect density.

Computing device 102 may also include sensors 220, which enable computing device 102 to sense various properties, variances, or characteristics of an environment in which computing device 102 operates. Sensors 220 may include any suitable type of sensor, such as an infrared sensor, proximity sensor, light sensor, acoustic sensor, magnetic sensor, temperature/thermal sensor, micro-electromechanical systems, camera sensor (e.g., charge-coupled device sensor or complementary-metal-oxide semiconductor sensor), capacitive sensor, and so on. In some cases, sensors 220 are useful in determining a distance between computing device 102 and a user. Alternately or additionally, sensors 220 enable interaction with, or receive input from, a user of computing device 102. In such a case, sensors 220 may include piezoelectric sensors, capacitive touch sensors, input sensing-logic associated with hardware switches (e.g., keyboards, snap-domes, or dial-pads), and so on.

Example Techniques

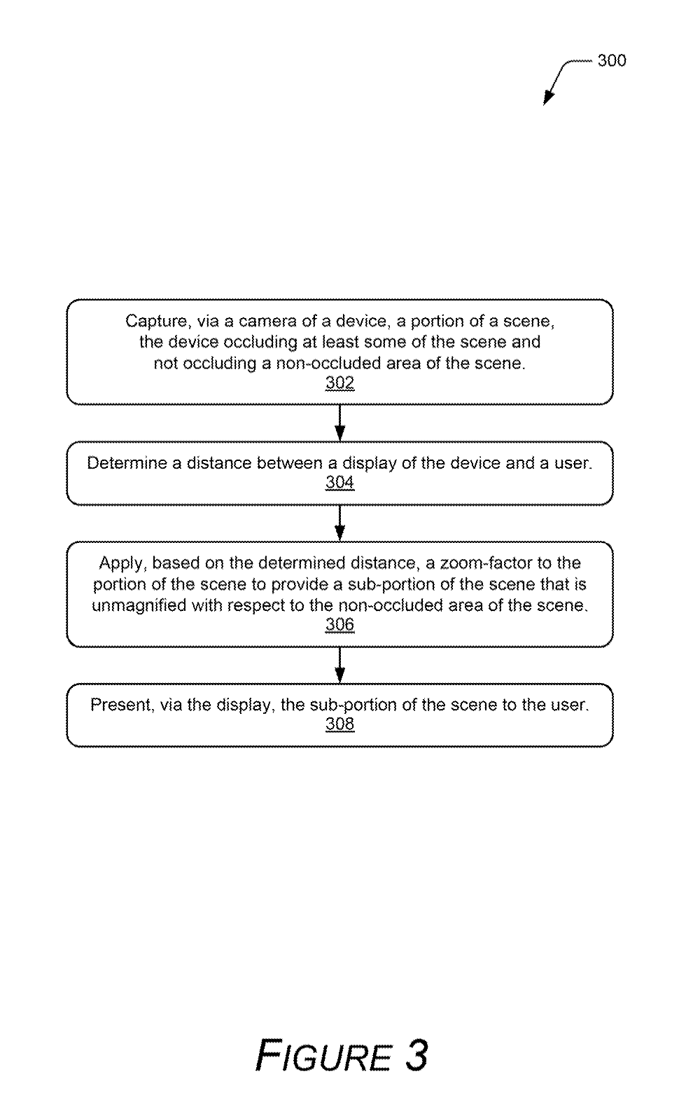

The following discussion describes techniques enabling display tiling for enhanced view modes. These techniques enable a computing device to alter a zoom-factor applied to a portion (or sub-portion) of a scene such that the portion of the scene appears unmagnified with respect to the scene that is not occluded by the computing device. By so doing, the portion of the scene presented by the display may “tile” into the scene enabling seamless presentation of contextual information to the user. These techniques can be implemented utilizing the previously described entities, such as view controller 210, context engine 212, forward-facing camera 214, or rear-facing camera 216 of FIG. 2. These techniques include example methods illustrated in FIGS. 3, 5, and 6, which are shown as operations performed by one or more entities. The orders in which operations of these methods are shown or described are not intended to be construed as a limitation, and any number or combination of the described method operations can be combined in any order to implement a method, or an alternate method, including any of those illustrated by FIGS. 3, 5, and 6.

FIG. 3 illustrates example method 300 of applying a zoom-factor to a portion of a scene.

At 302, a portion of a scene is captured by a camera of a device. The camera of the device captures the portion of the scene from scenery of an environment. The portion of the scene includes a sub-portion of the scene that is presented via a display of the device. The sub-portion of the scene may comprise the entire portion of scene (e.g., frame) captured by the camera or a smaller portion selected therefrom. Generally, the camera of the device is directed toward the scene, and the display faces a direction approximately opposite to that of the camera of the device. As such, a user viewing the scene may also view the display of the device and the sub-portion of scene presented thereby. In some cases, a user's view of the scene is partially occluded by a physical housing of the device.

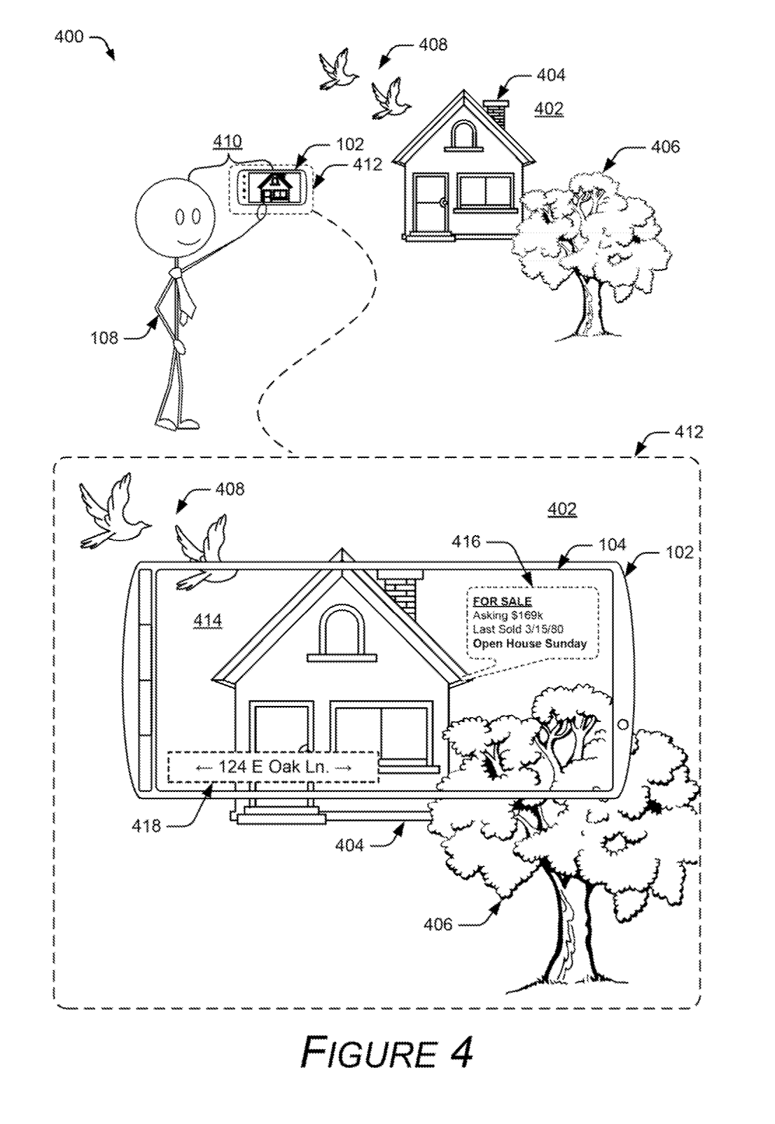

By way of example, consider example environment 400 of FIG. 4, which shows user 108 in the context of scene 402. Assume here that user 108 desires to purchase a house and is exploring a local real estate market with computing device 102. As user 108 orients computing device 102 toward elements of scene 402, forward-facing camera 214 captures imagery of scene 402. This captured imagery, referred to as a portion of scene 402, includes the elements of scene 402, such as house 404, tree 406, and birds 408. Here, note that the physical housing of computing device 102 occludes some of scene 402 and does not occlude a non-occluded area of scene 402.

At 304, a distance between a display of the device and a user is determined. More precisely, this distance can be the distance between the display and eyes of the user. The determined distance can be determined or estimated to any suitable level of accuracy, such to within approximately 10% to 25% of an actual distance. By way of example only, for a device held at an arm's length of approximately 36 inches, the distance can be determined to within an accuracy of about 3.6 to 9 inches. Thus, in this example, the distance is not necessarily determined at 36 inches but can range from approximately 27 to 45 inches. In other instances, the distance may be determined with more accuracy, such as to within approximately 9% or less of the actual distance. In some cases, the distance is determined by another camera or sensors of the device, such as a camera facing a same direction as the display (i.e., toward the user). The other camera may implement facial recognition or a focusing algorithm to determine the distance between the display and the user.

For example, facial recognition can detect facial features of a user when applied to imagery captured by the other camera of the device. A distance to the user is then determined based on the detected facial features of the user or geometries (i.e., distance or angular relations) thereof. Alternately or additionally, a focusing algorithm can determine the distance between the display and the user. The focusing algorithm monitors an amount of focal length adjustment applied to bring the user into focus. The focusing algorithm can then calculate (or estimate) the distance to the user based on a known focal length of the other camera's optical system (e.g., prime lens or zoom lens) and the amount of focal length adjustment applied.

In some cases, sensors of the device are used to determine a distance between the device and the user. For example, acoustic sensors of the device can monitor a voice of the user while the other camera tracks movement of the user's mouth. Based on an amount of time by which the user's voice and mouth movement are out of sync, a determination of the distance is made based on a difference between the speed of light and the speed of sound. Thus, the distance is determined based on visual detection of when the user's mouth moves versus an acoustical detection of when the user speaks.

In the context of the present example, view controller 210 receives an image of user 108 via rear-facing camera 216. View controller 210 then processes the image of user 108 with facial recognition to recognize eyes and other facial features of user 108. Based on a geometry of the recognized features, view controller 210 determines distance 410 by which computing device 102 is separated from the eyes of user 108.

At 306, a zoom-factor applied to the portion of the scene to provide a sub-portion of the scene. In some cases, the sub-portion of the scene includes the entire portion of the scene captured by the camera. The zoom-factor is applied to the portion of the scene based on the determined distance to the user. This is effective to provide the sub-portion of the scene such that the sub-portion of the scene appears unmagnified in relation to other scenery of the environment. Alternately or additionally, the zoom-factor is applied based on a characteristic of the display, such as a screen size, aspect ratio, pixel resolution, or an offset between the camera and the display.

Continuing the ongoing example, view controller 210 applies, based on distance 410, a zoom-factor to the portion of scene 402 to provide a sub-portion of scene 402. The zoom-factor is applied such that the sub-portion of scene 402 is unmagnified with respect to the non-occluded area of scene 402. Here, assume that the sub-portion of scene 402 comprises all of the portion of scene 402 that is captured by forward-facing camera 214.

At 308, the sub-portion of the scene is presented via the display of the device. The sub-portion of the scene appears unmagnified with respect to non-occluded areas of the scene. This may also be effective to permit the sub-portion of the scene to tile into the rest of the scene not occluded by the device. Tiling the sub-portion of the scene presented by the display can be effective to enable seamless or intuitive interaction with the scenery of the environment. Not only may the device appear mostly transparent to a user, but other contextual information can be presented to the user. For example, the device may detect particular elements within the sub-portion of the scene by optical recognition or geographical context, such as through the use of global positioning system (GPS) sensor. Contextual indicators associated with these elements can then be inserted into the sub-portion of the scene to provide the user with additional contextual information.

Alternately or additionally, enhanced view modes are applied to the sub-portions of the scene by leveraging capabilities of the camera. For example, a color palette or color distribution associated with the sub-portion of the scene can be altered based on the infrared wavelength imagery perceived by the camera. By so doing, the user is able to perceive aspects of the scene that are beyond the spectrum of visible light. Other enhanced view modes may include low-lux view modes, high-dynamic-range view modes, ultra-violet view modes, variable contrast view modes, and so on.

Concluding the present example, the sub-portion of scene 402 is presented by display 104. For visual clarity, a detailed view of scene 402 from a perspective of user 108 is shown at user view 412. As shown by user view 412, the portion of scene 402 captured by forward-facing camera 214 is zoomed to provide a sub-portion of scene 402 that is presented via display 206, shown as sub-portion 414. Here, context engine 212 determines, via a GPS module of computing device 102, a location and directional orientation of computing device 102. Context engine 212 then acquires contextual information associated with elements of scene 402, including home pricing information and navigational information. This contextual information is presented to user 108 by context engine 212 as address indicator 418 and real estate indicator 416, which is operable, via the ‘for sale’ hyperlink, to initiate contact with a realtor of house 404.

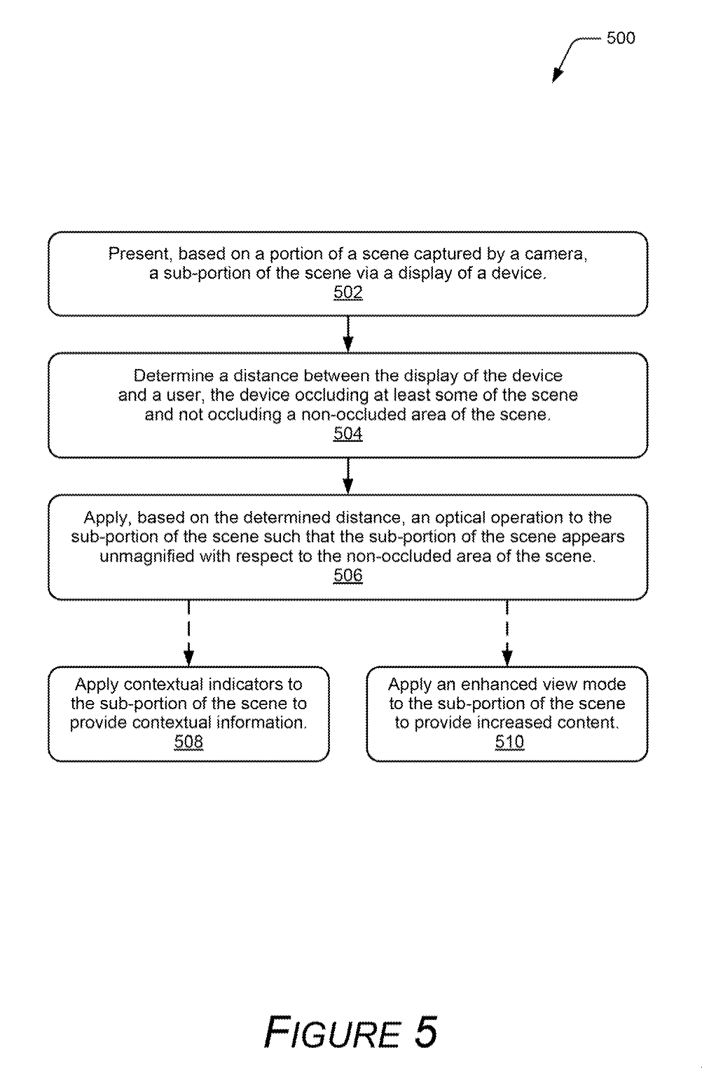

FIG. 5 illustrates methods 500 of display tiling in accordance with one or more embodiments.

At 502, a sub-portion of a scene is presented via a display of a device. The sub-portion of the scene is based on a portion of the scene that is captured by a camera of the device. The sub-portion of the scene may be an entire portion of the scene captured by the camera or any part thereof. In some cases, the camera and the display are mounted on opposing surfaces of the device and are directed in generally opposite directions. Generally, when the camera of the device is directed toward the scene, the display is directed away from the scene and toward a user. The device may be sized such that the user can view the sub-portion of the scene presented by the display, as well as other areas of the scene visible around the device. As such, the device (and display thereof) may occlude part of the scene from a view of the user, with a non-occluded area of the scene remaining at least partially viewable.

At 504, a distance between the display of the device and a user is determined. In some cases, a distance between the display and the eyes of the user is determined or estimated. This distance can be determined using another camera, transceiver, or sensors of the device, such as an acoustic sensor, infrared sensor, and the like. For example, a camera implementing a focusing-based algorithm can determine the distance based on a focal length adjustment made to bring the user into focus.

At 506, a zoom-factor applied to the sub-portion of the scene is altered based on the distance between the display and the user. This can be effective to cause the sub-portion of the scene to appear unmagnified with respect to other viewable areas of the scene. Thus, the sub-portion of the scene is presented such that the sub-portion of the scene substantially replicates a portion of the scene that is occluded by the device or display thereof. In some cases, parameters of other visual operations applied to the portion or sub-portion of the scene are altered. These other visual operations may include a pan (vertical or lateral), crop, or stretch applied to imagery captured by the camera. In such cases, the visual operation may be altered during post-capture image processing performed by the camera or another component of the device (e.g., graphic processor) before the sub-portion of the scene transmitted to the display for presentation.

Optionally at 508, contextual indicators are applied to the sub-portion of the scene to provide contextual information. As described herein, a contextual indicator may provide any suitable contextual information to the user, such as text, tags, navigation symbols, hyperlinks, and so on. In some cases, a data network (e.g., the Internet) is accessed to acquire the contextual information applied to the sub-portion of the scene. The user may also add contextual information to an element of a scene that may be accessed by other devices querying contextual information, such as by updating an entry associated with the element stored in the cloud or other online data repository.

Alternately or additionally, contextual indicators can be applied responsive to user input, such as touch input or voice input. For example, a user may select an element of the sub-portion of the scene for which additional context information is desired. Contextual information of the selected element can be queried based on the element's appearance, geographical context, and the like. Once contextual information for the selected element is acquired, a contextual indicator for the selected element can be inserted into the sub-portion of the scene to provide the desired contextual information.

Optionally at 510, an enhanced view mode is applied to the sub-portion of the scene to provide enhanced context. As described herein, the enhanced view mode may leverage capabilities of a camera to acquire visual information to apply the enhanced view mode to the sub-portion of the scene. The enhanced view mode may manipulate any suitable aspects of the imagery of the scene, such as by increasing luminance, adjusting contrast (e.g., HDR view mode), or filtering particular colors. Alternately or additionally, the enhanced view mode may visualize light beyond the visible spectrum, such as infrared or ultraviolet light.

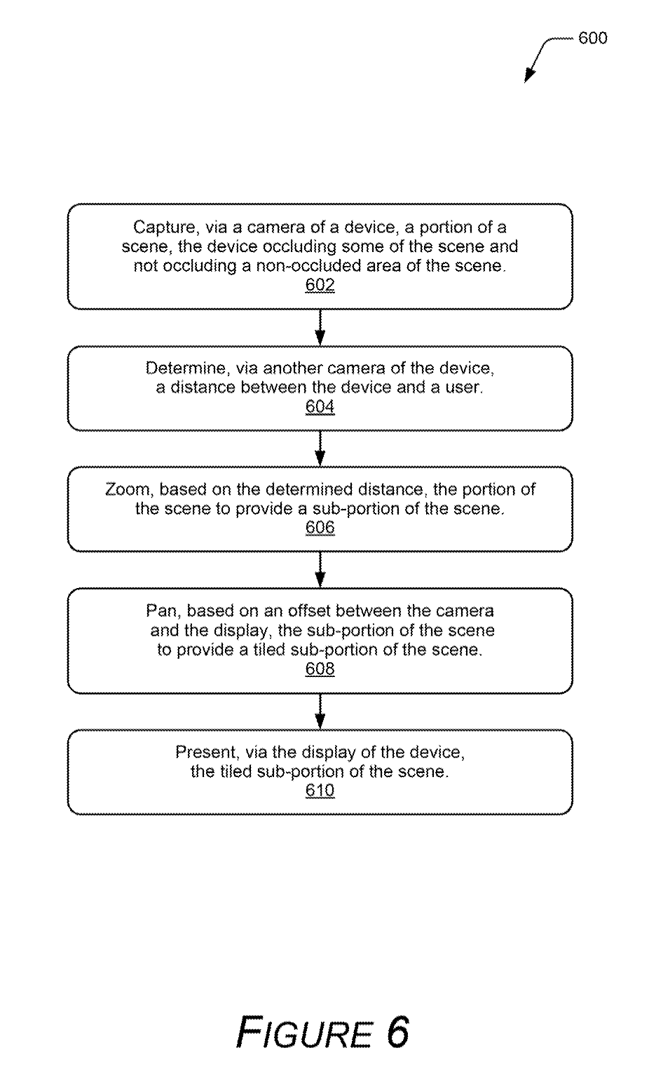

FIG. 6 illustrates example method 600 of presenting tiled scenery via a display of a device.

At 602, a portion of a scene is captured by a camera of a device. The portion of the scene is captured from scenery of an environment in which the device operates. The device may occlude at least a portion of the scene from a view of a user. In some cases, the portion of the scene captured is determined by how the user orients the device with respect to the scenery of the environment. By way of example, consider method 600 in the context of FIG. 1, in which user 108 is standing in the field at night. Here, forward-facing camera 214 of computing device 102 captures a portion of scene 106. As shown in user view 112, other portions of scene 106 are viewable by user 108, such as the top of tree 110.

At 604, a distance between the device and a user is determined. In some cases, the distance is determined using another camera of the device that faces a direction opposite of the camera and toward the user. In such cases, a focusing algorithm or facial detection can be implanted to determine the distance between the device and the user. In other cases, the distance is determined via a wireless transceiver or sensor of the device, such as an acoustic sensor, infrared sensor, proximity sensor, motion sensor, and the like. Continuing the ongoing example, view controller 210 of computing device 102 implements facial recognition to determine a distance between computing device 102 and user 108.

At 606, the portion of the scene is zoomed to provide a sub-portion of the scene. The portion of the scene is zoomed based on the distance between the display and the user. The sub-portion of the scene may comprise all of the portion captured by the camera or any part thereof. The sub-portion of the scene may be provided such that imagery of the scene is unmagnified. Alternately or additionally, the sub-portion of the scene is altered such that edges of the sub-portion of the scene match scenery not occluded at edges of a physical housing of the device. In the context of the present example, view controller 210 zooms the portion of scene 106 captured by forward-facing camera 214 to provide a sub-portion of scene 106.

At 608, the sub-portion of the scene is panned to provide a tiled sub-portion of the scene. The sub-portion of the scene can be panned based on an offset between the camera of the device and a display of the device. In some cases, the offset between the camera and the display is known based on a physical design of the device. In other cases, the offset between the camera and the display is determined by a calibration process. The calibration process may involve obtaining feedback from a user with respect to imagery presented by the display.

For example, a calibration indicator can be presented over a sub-portion of the scene. A position of this calibration indicator is indexed with respect to a portion of the scene as captured by a camera. User input received through the calibration indicator indicates a reference point that is indexed with respect to content as presented by the display. Based on the respective positions of the calibration indicator and the reference point, the offset between the camera and a display is determined. This calibration process may be used to determine one or more reference points of the display, such as a center, edge, corner, and the like.

Alternately or additionally, an aspect ratio of the sub-portion of the scene is altered to provide the tiled part of the scene. The aspect ratio may be altered based on a difference in an aspect ratio (frame format) of the camera or an aspect ratio of the display. Altering the aspect ratio may include cropping or stretching the portion of the scene captured by the camera. In some cases, altering the aspect ratio or zooming of the portion of the scene is based on calibration information determined as described above. Continuing the ongoing example, view controller 210 pans the sub-portion of scene 106 to provide a tiled sub-portion of scene 106.

At 610, the tiled sub-portion of the scene is presented via the display of the device. Presentation of the tiled sub-portion of the scene may enable increased context to be exposed through an enhanced view mode or contextual indicators. In some cases, application of an enhanced view mode exposes visual aspects of the sub-portion of the scene that are beyond the visual range of a user (e.g., night-vision, infrared). In other cases, insertion of contextual indicators enables intuitive interaction with elements of the tiled sub-portion of the scene, such as navigational or informational indicators, tags, links, and the like. Concluding the present example, view controller 210 applies a low-lux view mode (e.g., night vision mode) to the sub-portion of scene 106, which is shown as sub-portion 114 of scene 106. By so doing, elements of sub-portion 114 are exposed that were previously not perceivable by user 108 due to low levels of ambient light.

Example Electronic Device

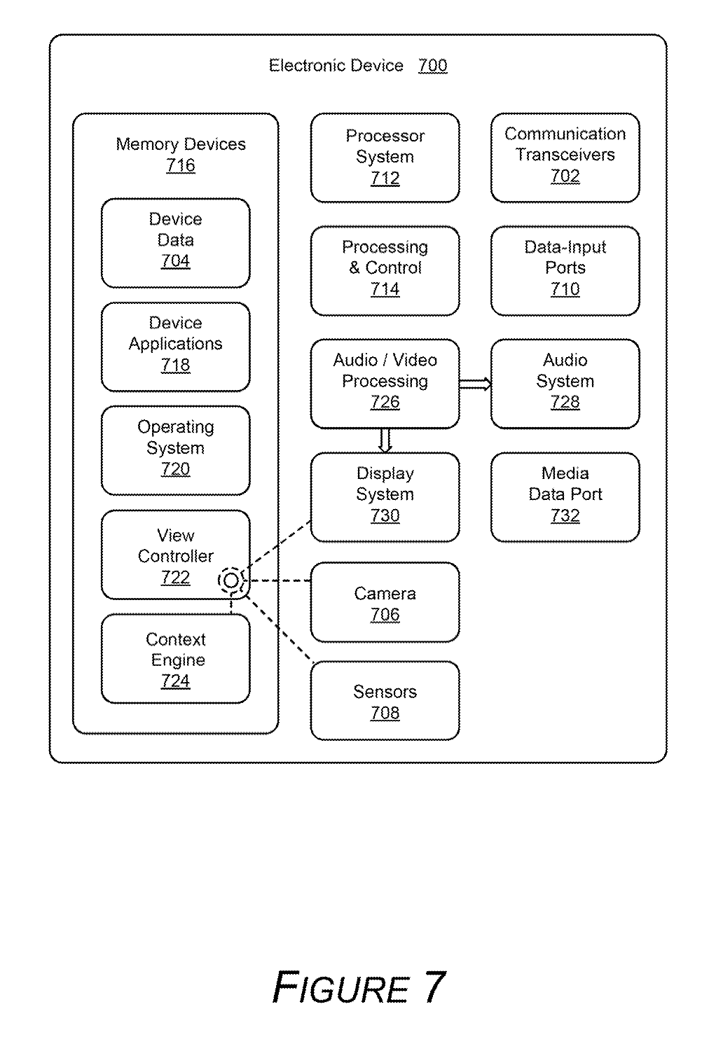

FIG. 7 illustrates various components of an example electronic device 700 that can be implemented as a computing device as described with reference to any of the previous FIGS. 1 through 6. Electronic device 700 can be, or include, many different types of devices capable of implementing display tiling for enhanced view modes. For example, electronic device 700 may include a camera (compact or single-lens reflex), phone, personal navigation device, gaming device, Web browsing platform, pager, media player, or any other type of electronic device, such as the computing device 102 described with reference to FIG. 1.

Electronic device 700 includes communication transceivers 702 that enable wired or wireless communication of device data 704, such as received data and transmitted data. Example communication transceivers include WPAN radios compliant with various Institute of Electrical and Electronics Engineers (IEEE) 802.15 (Bluetooth™) standards, WLAN radios compliant with any of the various IEEE 802.11 (WiFi™) standards, WWAN (3GPP-compliant) radios for cellular telephony, wireless metropolitan area network radios compliant with various IEEE 802.16 (WiMAX™) standards, and wired LAN Ethernet transceivers.

In embodiments, the electronic device 700 includes camera 706, such as forward-facing camera 214 or rear-facing camera 216 as described with reference to FIG. 2. The electronic device 700 may also include sensors 708, such as an infrared sensor, light sensor, proximity sensor, capacitive sensor, acoustic sensor, or magnetic sensor as described above. The camera 706 and sensors 708 can be implemented to facilitate various embodiments of display tiling for enhanced view modes.

Electronic device 700 may also include one or more data-input ports 710 via which any type of data, media content, and inputs can be received, such as user-selectable inputs, messages, music, television content, recorded video content, and any other type of audio, video, or image data received from any content or data source. Data-input ports 710 may include USB ports, coaxial cable ports, and other serial or parallel connectors (including internal connectors) for flash memory, DVDs, CDs, and the like. These data-input ports may be used to couple the electronic device to components, peripherals, or accessories such as keyboards, microphones, or cameras.

Electronic device 700 of this example includes processor system 712 (e.g., any of application processors, microprocessors, digital-signal processors, controllers, and the like) or a processor and memory system (e.g., implemented in a system-on-chip), which process computer-executable instructions to control operation of the device. A processing system may be implemented at least partially in hardware, which can include components of an integrated circuit or on-chip system, digital-signal processor, application-specific integrated circuit, field-programmable gate array, a complex programmable logic device, and other implementations in silicon and other hardware. Alternatively or in addition, the electronic device can be implemented with any one or combination of software, hardware, firmware, or fixed-logic circuitry that is implemented in connection with processing and control circuits, which are generally identified at 714. Although not shown, electronic device 700 can include a system bus, crossbar, interlink, or data-transfer system that couples the various components within the device. A system bus can include any one or combination of different bus structures, such as a memory bus or memory controller, data protocol/format converter, a peripheral bus, a universal serial bus, a processor bus, or local bus that utilizes any of a variety of bus architectures.

Electronic device 700 also includes one or more memory devices 716 that enable data storage, examples of which include random-access memory, non-volatile memory (e.g., read-only memory (ROM), flash memory, EPROM, EEPROM, etc.), and a disk storage device. Memory devices 716 are implemented at least in part as physical devices that store information (e.g., digital or analog values) in storage media, which do not include propagating signals or waveforms. The storage media may be implemented as any suitable types of media such as electronic, magnetic, optic, mechanical, quantum, atomic, and so on. Memory devices 716 provide data-storage mechanisms to store the device data 704, other types of information or data, and various device applications 718 (e.g., software applications). For example, operating system 720 can be maintained as software instructions within memory devices 716 and executed by processors 712. In some aspects, view controller 722 and context engine 724 are embodied in memory devices 716 of electronic device 700 as executable instructions or code. Although represented as a software implementation, view controller 722 or context engine 724 may be implemented as any form of a control application, software application, signal processing and control module, firmware that is installed on the device, a hardware implementation of the controller, and so on.

Electronic device 700 also includes audio and video processing system 726 that processes audio data and passes through the audio and video data to audio system 728 and to display system 730. Audio system 728 and display system 730 may include any modules that process, display, or otherwise render audio, video, display, or image data, such as view controller 722 or context engine 724. Display data and audio signals can be communicated to an audio component and to a display component via a radio-frequency link, S-video link, HDMI, composite video link, component video link, digital video interface, analog audio connection, or other similar communication link, such as media data port 732. In some implementations, audio system 728 and display system 730 are external components to electronic device 700. Alternatively or additionally, display system 730 can be an integrated component of the example electronic device, such as part of an integrated display and touch interface. As described above, view controller 722 may manage or control display system 730, or components thereof, in aspects of display tiling for enhanced view modes.

We claim:

1. A method comprising:
capturing, via a camera of a device, a portion of a scene, the device occluding at least some of the scene and not occluding a non-occluded area of the scene;
determining a distance between a display of the device and a user, the display facing toward the user and facing a direction opposite to that of the camera;
applying, based on the determined distance between the display and the user, a zoom-factor to the portion of the scene to provide a sub-portion of the scene that is unmagnified with respect to the non-occluded area of the scene; and
presenting, via the display, the sub-portion of the scene to the user.

2. The method of claim 1 wherein the camera is a first camera and wherein determining the distance comprises determining, via a second camera facing a same direction as the display, the distance between the display and the user.

3. The method of claim 1 wherein determining the distance comprises determining, via a sensor of the device, the distance between the display and the user, the sensor of the device comprising one of a proximity sensor, infrared sensor, acoustic sensor, and motion sensor.

4. The method of claim 1 wherein the sub-portion of the scene presented via the display comprises all of the portion of the scene captured by the camera.

5. The method of claim 1 further comprising adding a contextual indicator to the sub-portion of the scene presented via the display, the contextual indicator comprising one of a navigational indicator, social indicator, service-related indicator, product-related indicator, news-related indicator, promotional indicator, and informational indicator.

6. The method of claim 5 wherein adding the contextual indicator is responsive to receiving user input associated with the sub-portion of the scene presented via the display.

7. The method of claim 1 further comprising applying an enhanced view mode to the sub-portion of the scene presented via the display.

8. The method of claim 7 wherein the enhanced view mode comprises one of a lux-enhancing view mode, high-dynamic-range view mode, infrared view mode, ultraviolet view mode, contrast-enhancing view mode, and color-filtering view mode.

9. The method of claim 1 wherein applying the zoom-factor to the portion of the scene is further based on a size, aspect ratio, or resolution of the display via which the sub-portion of the scene is presented.

10. An apparatus comprising:
a first camera configured to capture a portion of a scene to which the first camera is directed;
a display facing a direction opposite to that of the first camera and configured to present, based on the portion of the scene, a sub-portion of the scene, the display occluding at least some of the scene and not occluding a non-occluded area of the scene;
a second camera facing in a same direction as the display; and
a view controller configured to:
determine, via the second camera, a distance between a user and the display presenting the sub-portion of the scene;
apply, based on the determined distance, an optical operation to the sub-portion of the scene such that the sub-portion of the scene appears unmagnified with respect to the non-occluded area of the scene; and
present, via the display, the sub-portion of the scene to the user.

11. The apparatus of claim 10 wherein the sub-portion of the scene is presented such that the sub-portion of the scene substantially replicates a part of the scene that is occluded by the display of the apparatus.

12. The apparatus of claim 10 wherein the optical operation applied to the sub-portion of the scene comprises one of a pan operation or zoom operation that is applied prior to presenting the sub-portion via the display of the apparatus.

13. The apparatus of claim 10 further comprising a context engine that is configured to add a contextual indicator to the sub-portion of the scene presented by the display, the contextual indicator comprising one of a navigational indicator, social indicator, service-related indicator, product-related indicator, news-related indicator, promotional indicator, and informational indicator.

14. The apparatus of claim 10 wherein the view controller is further configured to apply an enhanced view mode to the sub-portion of the scene presented by the display, the enhanced view mode comprising one of a lux-enhancing view mode, high-dynamic-range view mode, infrared view mode, ultraviolet view mode, contrast-enhancing view mode, and color-filtering view mode.

15. An apparatus comprising:
a camera configured to capture a portion of a scene toward which the camera is facing;
a display facing a user and facing a direction approximately opposite to that of the camera, the display occluding at least some of the scene and not occluding a non-occluded area of the scene;
a sensor facing in a same direction as the display; and
a view controller configured to:
determine, via the sensor, a distance between a user and the display of the apparatus;
apply, based on the determined distance between the user and the display, a zoom-factor to the portion of the scene to provide a sub-portion of the scene that is unmagnified with respect to the non-occluded area of the scene; and
present, via the display, the sub-portion of the scene to the user.

16. The apparatus of claim 15 wherein the sensor facing the user comprises one of a proximity sensor, infrared sensor, acoustic sensor, and another camera.

17. The apparatus of claim 15 wherein the view controller is further configured to apply, based on an offset between the camera and a display of the apparatus, a pan to the sub-portion of the scene such that elements of the sub-portion of the scene appear aligned with elements of the non-occluded area of the scene.

18. The apparatus of claim 15 wherein the sub-portion of the scene occupies approximately an entire viewable area of the display of the apparatus.

19. The apparatus of claim 15 further comprising a context engine that is configured to add a contextual indicator to the sub-portion of the scene to provide contextual information to the user.

20. The apparatus of claim 15 wherein the view controller is further configured to apply an enhanced view mode to the sub-portion of the scene to provide increased visual context to the user.
